(19) United States
(12) Patent Application Publication
(10) Pub. No.: US 2011/0036990 A1
(43) Pub. Date: Feb. 17, 2011

(54) PLATEN TO CONTROL CHARGE ACCUMULATION

(75) Inventors: Dale K. Stone, Lynnfield, MA (US); Lyudmila Stone, Lynnfield, MA (US); Julian G. Blake, Gloucester, MA (US); Frederick B. Ammon, Essex, MA (US); David E. Suuronen, Newburyport, MA (US)

Correspondence Address: VARIAN SEMICONDUCTOR EQUIPMENT ASSC., INC., 35 DORY RD., GLOUCESTER, MA, 01930-2297, US

(73) Assignee: VARIAN SEMICONDUCTOR EQUIPMENT ASSOCIATES, INC., Gloucester, MA (US)

(21) Appl. No.: 12/540,225

(22) Filed: Aug. 12, 2009

(51) Int. Cl. H05F 1/00; G21G 5/00; H01J 27/00

(52) U.S. Cl. 250/423 R; 250/492.3; 361/212

(57) ABSTRACT

An embossed platen to control charge accumulation includes a dielectric layer, a plurality of embossments on a surface of the dielectric layer to support a workpiece, each of a first plurality of the plurality of embossments having a conductive portion to contact a backside of the workpiece when the workpiece is in a clamped position, and a conductor to electrically couple the conductive portion of the first plurality of embossments to ground. An ion implanter having such an embossed platen is also provided.

### FIELD

This disclosure relates to platens, and more particularly to embossed platens to control charge accumulation.

### BACKGROUND

Platens are used to secure and support a workpiece for processing. An embossed platen has a plurality of embossments on the clamping surface of the platen to support the workpiece. These embossments may also be referred to as “;pins,” “mesas,” “bumps,” or “protrusions.” In general, supporting the workpiece on such embossments is beneficial since it decreases contact with the backside of the workpiece. Less contact with the backside of the workpiece results in less particle generation which may be critical in some processing applications. In addition, some processing applications may provide a backside cooling gas to cool the backside of the workpiece during processing. The embossments enable improved gas distribution in such instances.

In some processing applications, charge may accumulate on the workpiece as it is being supported by the embossed platen. For example, in an ion implanting processing application, energetic ions are accelerated towards a front surface of the workpiece. Since the energetic ions are charged particles, charge may accumulate on the front surface of the workpiece. If the accumulated charge becomes excessive, it may lead to damage of devices being formed on the workpiece. In a plasma doping ion implanter where the workpiece is positioned in the same chamber as plasma, excessive charge accumulation can also lead to doping non-uniformities, micro-loading, and arcing. Hence, the throughput of the plasma doping ion implanter may be intentionally limited in some instances to avoid excessive charge accumulation.

One conventional solution to controlling charge accumulation uses three spring loaded grounding pins that contact a backside of the workpiece to provide a path to ground when the workpiece is in a clamped position. One drawback of this solution is that the spring loaded grounding pins are limited to three pins given space considerations. As such, the effectiveness of this grounding arrangement to dissipate excessive charge build up is limited. Another drawback of this solution is that the contact points of the spring loaded grounding pins have sharp edges that can cause damage to the backside of the workpiece. Damage to the backside of the workpiece can also generate unwanted particles (contamination) which may be critical to limit in some processing applications. Yet another drawback is that insufficient electrical contact of the grounding pins to the backside of the workpiece may occur due to improper installation, damage, or wear. Yet another drawback is that there is no flexibility to control the number of grounding contact points to the workpiece.

Accordingly, there is a need for an improved embossed platen to control charge accumulation.

### SUMMARY

According to a first aspect of the disclosure an embossed platen is provided. The embossed platen includes a dielectric layer, a plurality of embossments on a surface of the dielectric layer to support a workpiece, each of a first plurality of the plurality of embossments having a conductive portion to contact a backside of the workpiece when the workpiece is in a clamped position, and a conductor to electrically couple the conductive portion of the first plurality of embossments to ground.

According to yet another aspect of the disclosure, an ion implanter is provided. The ion implanter includes an ion generator configured to generate ions and direct the ions towards a front surface of a workpiece, and an embossed platen. The embossed platen includes a dielectric layer, a plurality of embossments on a surface of the dielectric layer to support the workpiece, each of a first plurality of the plurality of embossments having a conductive portion to contact a backside of the workpiece when the workpiece is in a clamped position, and a conductor to electrically couple the conductive portion of the first plurality of embossments to ground.

According to yet another embodiment, another embossed platen is provided. The embossed platen includes a dielectric layer, a plurality of embossments on a surface of the dielectric layer to support a workpiece, at least one of the plurality of embossments having a conductive portion to contact a backside of the workpiece when the workpiece is in a clamped position, and a conductor to electrically couple the conductive portion to ground.

### BRIEF DESCRIPTION OF THE DRAWINGS

For a better understanding of the present invention, reference is made to the accompanying drawings, which are incorporated herein by reference and in which:

FIG. 1 is a block diagram of a beam line ion implanter having an embossed platen consistent with an embodiment of the disclosure;

FIG. 2 is a block diagram of a plasma doping ion implanter having an embossed platen consistent with an embodiment of the disclosure;

FIG. 3 is a plan view of an embossed platen consistent with an embodiment of the disclosure;

FIG. 4 is a partial cross sectional view of the embossed platen of FIG. 3 taken along the line 4-4 of FIG. 3;

FIG. 5 is a perspective view of one embossment;

FIGS. 6A-C are partial cross sectional views of differing embodiments of embossed platens consistent with the disclosure;

FIG. 7 is a block diagram of an embossed platen having a switch to selectively couple differing patterns of embossments to ground; and

FIG. 8 is a plan view of an embodiment of an embossed platen having a pattern of grounded embossments controlled by the switch of FIG. 7.

### DETAILED DESCRIPTION

The disclosure may be described herein in connection with an ion implanter that utilizes an embossed platen to support a workpiece. However, the disclosure can be used with other systems that utilize an embossed platen to support a workpiece. The workpiece may also be described herein as a semiconductor wafer. However, the workpiece may also include, but not be limited to, a solar cell, a polymer substrate, and a flat panel. Thus, the disclosure is not limited to the specific embodiments described below.

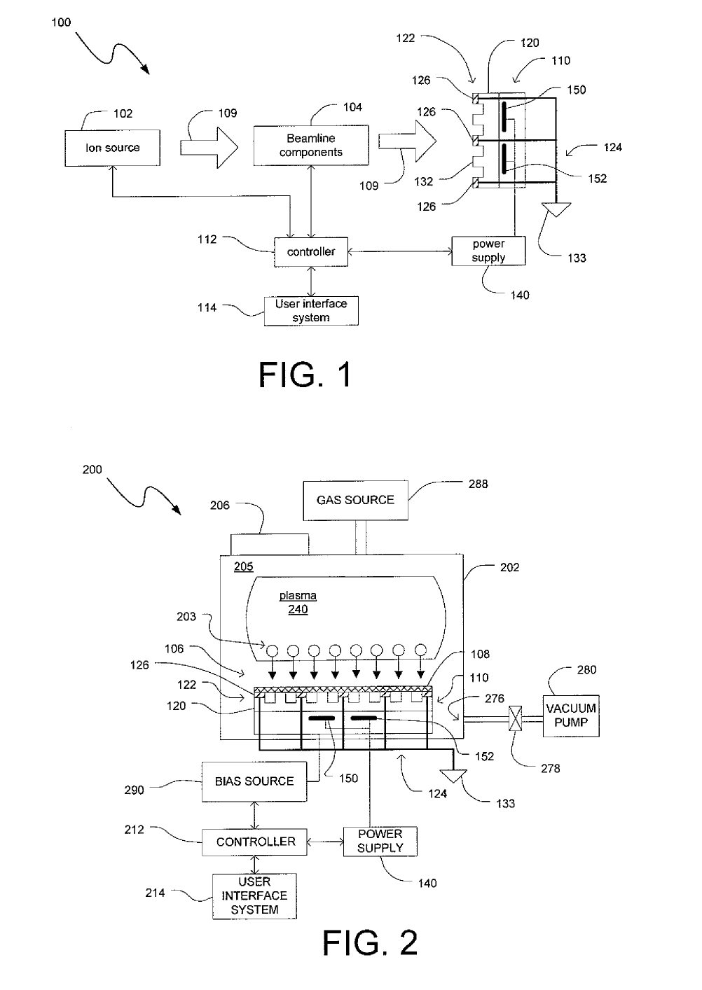

Turning to FIG. 1, a block diagram of a beam line ion implanter 100 having an embossed platen 110 consistent with an embodiment of the disclosure is illustrated. The beam line ion implanter 100 may also have an ion source 102, beamline components 104, a controller 112, and a user interface system 114. The ion source 102 may be an indirectly heated cathode (IHC) source or any other type of source known to those skilled in the art to generate plasma from an input feed gas. An extraction electrode assembly (not illustrated) is biased to extract ions from an aperture of the ion source 102 into a well defined ion beam 109. Differing beamline components 104 known in the art may control and modify the ion beam 109 as it travels towards a front surface of a workpiece (not illustrated) supported by the embossed platen 110. The ion beam 109 may be a spot beam or ribbon beam and the ion beam 109 may be distributed across the front surface of the workpiece by ion beam movement, workpiece movement, or a combination of the two.

The controller 112 can be or include a general-purpose computer or network of general-purpose computers that may be programmed to perform desired input/output functions. The controller 112 may also include communication devices, data storage devices, and software. The user interface system 114 may include devices such as touch screens, keyboards, user pointing devices, displays, printers, etc. to allow a user to input commands and/or data and/or to monitor the beam line ion implanter 100 via the controller. The controller 112 may receive signals from the user interface system 114 and/or one or more components or sensors of the beam line ion implanter 100. The controller 112 may control components of the beam line ion implanter 100 in response thereto.

The embossed platen 110 may be an electrostatic clamp having a dielectric layer 120. The dielectric layer 120 has a plurality of embossments 122 to support a workpiece (not illustrated) in a clamped position. For clarity of illustration, the cross sectional views of the embossed platen 110 shows only five embossments 122 of an exaggerated size. Those skilled in the art will recognize that the clamping surface may have many hundreds of embossments depending on the size of the clamping surface and embossments, as well as the spacing of the embossments.

The embossed platen 110 may also have a first plurality of embossments having a conductive portion 126. A conductor 124 is electrically coupled to each of conductive portion 126 to provide a path to ground 133. One or more electrodes 150, 152 of the embossed platen 110 may be positioned below the dielectric layer 120 and may be further coupled to a power supply 140. Depending on the number and position of the conductive portions 126 relative to the underlying electrodes 150, 152, one or more openings may be patterned into the electrodes 150, 152 to allow the conductor 124 to pass through openings in the electrodes 150, 152. The openings in the electrodes 150, 152 should allow for sufficient spacing between them and the conductor 124 to prevent undesired currents from flowing between the same. The power supply 140 may provide a DC or AC voltage signal to the electrodes 150, 152 in order to create an electrostatic force to clamp the workpiece in a clamped position on the plurality embossments 122. In one embodiment, the embossed platen 110 may include six electrodes and differing AC voltage signals with differing phases may be applied to each electrode so that at any one time there are an equal number of positively charged electrodes and negatively charged electrodes.

Turning to FIG. 2, a block diagram of a plasma doping ion implanter 200 is illustrated having an embossed platen 110 consistent with that earlier detailed with respect to FIG. 1 and hence any repetitive description is omitted herein for clarity. In contrast to FIG. 1, a workpiece 108 is illustrated in a clamped position supported by the embossments 122 of the embossed platen 110. The plasma doping ion implanter 200 is illustrated as a stand alone system in FIG. 2, but alternatively may be part of a cluster tool including other processing apparatuses.

The plasma doping ion implanter 200 may include a process chamber 202, a gas source 288, a vacuum pump 280, a plasma source 206, a bias source 290, a controller 212, and a user interface system 214. The gas source 288 provides a gas to an enclosed volume 205 of the process chamber 202. The vacuum pump 280 evacuates the process chamber 202 through an exhaust port 276 to create a high vacuum condition within the process chamber 202. The vacuum pump 280 may include a turbo pump, and/or a mechanical pump. An exhaust valve 278 controls the exhaust conductance through the exhaust port 276.

The plasma source 206 is configured to generate plasma 240 in the process chamber 202. The plasma source 206 may be any plasma source known to those in the art such as an inductively coupled plasma (ICP) source, a capacitively coupled to plasma (CCP) source, a microwave (MW) source, a glow-discharge (GD) source, a helicon source, or a combination thereof.

The bias source 290 provides a bias signal to the embossed platen 110 and the workpiece 108 supported thereby. The bias source 290 may be a DC power supply to supply a DC bias signal or an RF power supply to supply an RiF bias signal depending on the type of plasma source 206. In one embodiment, the DC bias signal is a pulsed DC bias signal with ON and OFF periods to accelerate ions 203 from the plasma 240 to the workpiece during the ON periods. Controlling the duty cycle and amplitude of such a pulsed DC bias signal can influence the dose and energy of the ions 203. The plasma doping apparatus may also include a controller 212 and a user interface system 214 of similar structure to those detailed with respect to FIG. 1. For clarity of illustration, the controller 212 is illustrated as communicating only with the bias source 290, the power supply 140, and user interface system 214. However, the controller 212 may receive input signals and provide output control signals to other components of the plasma doping ion implanter 200.

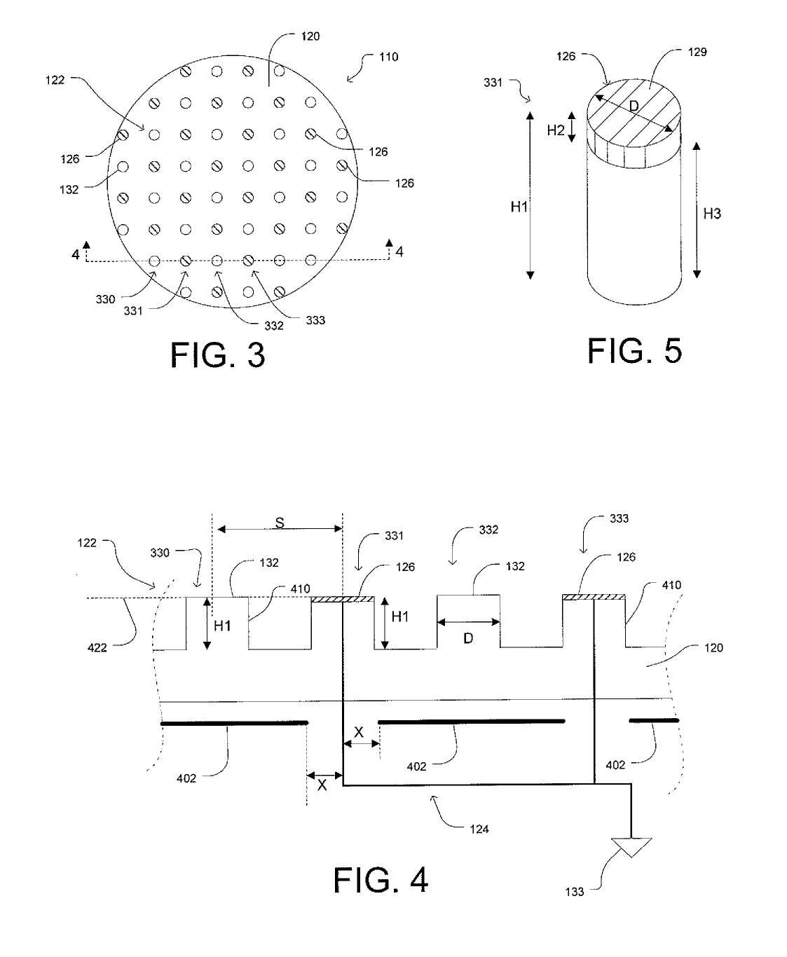

Turning to FIG. 3, a plan view of the embossed platen 110 and plurality of embossments 122 is illustrated. Some of the embossments 122 have a conductive portion 126 that contacts a backside of a workpiece when the workpiece is in a clamped position. Other embossments 122 may not have a conductive portion. In the embodiment of FIG. 3, a total of fifty two embossments are illustrated where greater than 40% of the total have a conductive portion 126 (twenty five of the fifty two embossments or 48%). In other embodiments, greater than 70% of the total number of embossments may have a conductive portion 126. In yet other embodiments, 100% of the total number of embossments may have a conductive portion 126. Those skilled in the art will recognize that the total number of embossments 122 may be much higher than that illustrated in FIG. 3 depending on the size of the embossments, the size of the clamping surface, and the spacing between embossments. In general, the number of embossments selected to have a conductive portion 126 is a tradeoff between charge control and clamping force. The more embossments with conductive portions 126 generally provides for improved charge control but lessens the maximum clamping force since there is less dielectric layer surface area proximate the workpiece.

Turning to FIG. 4, a partial cross sectional view of the embossed platen I 10 of FIG. 3 taken along the line 4-4 of FIG. 3 is illustrated. Each embossment may have a cylindrical shape with a cylindrical sidewall 410. Four embossments 330, 331, 332, 333 are illustrated in FIG. 4 where two embossments 331, 333 have a conductive portion 126 and two other embossments 330, 332 have a non-conductive top planar surface 132. The conductive portion 126 in this embodiment is fixed to a top surface of selected embossments. Each embossment 330, 331, 332, 333 may have a height (H1) that may be between about 5-12 micrometers (μm). A diameter (D) of the top planar disk shape may be about 0.2 to 1.0 millimeters (mm). Center to center spacing (S) between each embossment may be between about 7-8 mm in some embodiments. Each embossment may be fabricated of a harder material including, but not limited to, silicon carbide (SiC) and aluminum oxide (Al₂O₃). Alternatively, each embossment may be fabricated of a relatively softer material including, but not limited to, silicon dioxide (SiO₂), silicon (Si), silicon nitride (Si₃N₄), and a polyamide. The conductive portion 126 may be fabricated of a conductive material such as diamond like carbon (DLC) or aluminum.

Advantageously, a selected number of embossments 122 may have a conductive portion 126 that contacts a backside of the workpiece in a clamped position such as embossments 331, 333. The grounded embossments 331, 333 also have a height (H1) about the same as the other non-grounded embossments 330, 332 such that the top surface of each embossment 330, 331, 332, 333 is about level with a respective plane 422. The top surface of each grounded embossment 331, 333 and non-grounded embossment 330, 332 may be a flat planar disk shaped surface that is polished to produce a level surface level with a plane 422 that supports the backside of a workpiece.

An underlying electrode 402 may have apertures therein to allow the conductor 124 coupled to the conductive portions 126 to pass through the same. The apertures may be sized large enough so the conductor 124 can pass there through with sufficient spacing (X) to prevent undesired currents from flowing between the conductor 124 and electrode 402. In one example, a spacing (X) of about 1.5 to 2.0 mm between the electrode 402 and conductor 124 is sufficient.

FIG. 5 is a perspective view of one embossment 331 having a cylindrical shape. The conductive portion 126 in this embodiment is fixed to a top surface of the embossment to substantially cover the same. The conductive portion 126 has a planar disk shaped surface 129 to contact a backside of the workpiece when the workpiece is in a clamped position. The conductive portion 126 may have a height (H2) such that the total height (H1) of the grounded embossment 331 is about the same as non-grounded embossments (H1=H3+H2).

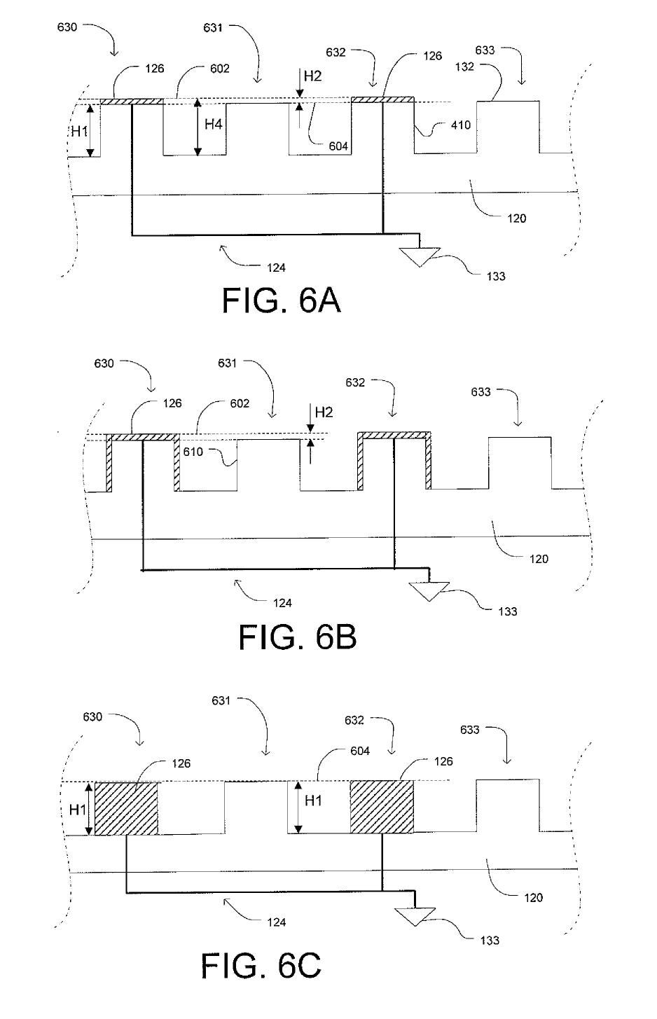

Turning to FIGS. 6A-6C, partial cross sectional views of additional embodiments with various conductive portions 126 are illustrated. Each of FIGS. 6A-6C illustrate four embossments 630, 6311 632, 633 where two embossments 630, 632 have a conductive portion 126 to contact a backside of the workpiece when the workpiece is in a clamped position. The other two embossments 631, 633 are non-grounded embossments. In the embodiment of FIG. 6A, the conductive portion 126 may be fixed to a top surface of the embossment and have a height (42). The height (42) of the conductive portion may only be about 1 micron such that the height of the grounded embossments 630, 632 level with a plane 602 may be about 1 micron higher than the height of the non-grounded embossments 631, 633 level with another plane 604. When the workpiece is clamped under typical clamping force, the workpiece should deflect enough to contact not only the grounded embossments 630, 632 but also any adjacent non-grounded embossments 631, 633. In the embodiment of FIG. 6B, the conductive portion 126 may be coated about an entire periphery of the embossments 630, 632. For a cylindrical shaped embossment, the cylindrical sidewall 610 may also be coated with the conductive portion 126. In the embodiment of FIG. 6C, the entire embossments 630, 632 may be fabricated of the conductive portion 126 having a height (H1) similar to the height of the non-grounded embossments 631, 633 level with the plane 604.

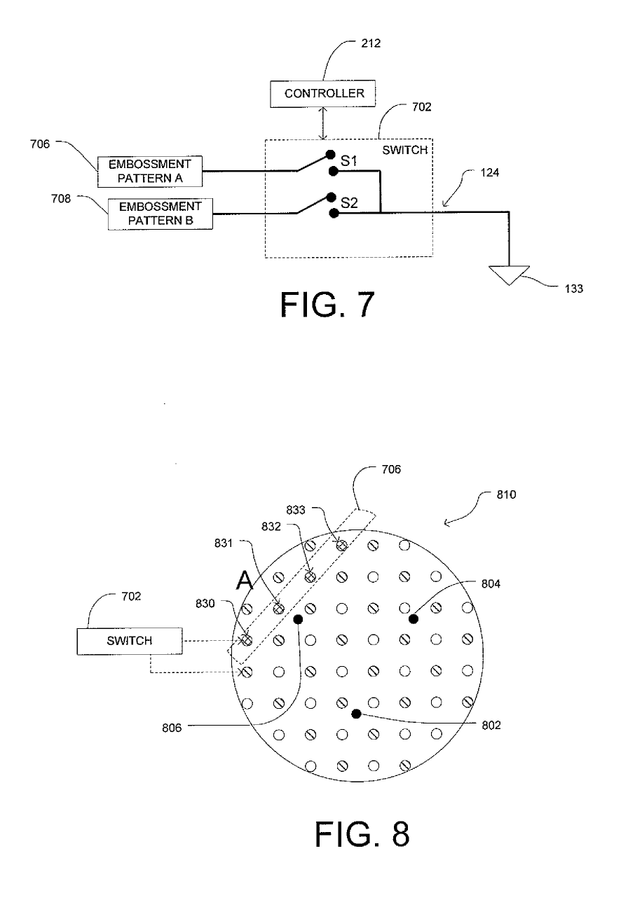

Turning to FIG. 7, a block diagram of an embossed platen including a switch 702 to selectively couple all or a subset of the grounded embossments to ground 133 is illustrated. The switch 702 may be controlled by the controller 212 earlier detailed with respect to FIG. 2. The switch 702 may include differing switch portions to couple differing patterns of grounded embossments to ground 133. For example, one switch portion (S1) may couple “embossment pattern A” 706 of the grounded embossments to ground when closed, and another switch portion (S2) may couple “embossment pattern B” 708 of the grounded embossments to ground 133 when closed. Although two switch portions are illustrated, any number of switching portions and associated patterns of grounded embossments could be used.

In operation, the controller 212 is configured to control a position of the switch 702 to couple all grounded embossments or a subset of all grounded embossments to ground 133. For example, with switch portions Si and S2 closed, all grounded embossments would be coupled to ground 133. With switch portion S1 closed and S2 open, only “embossment pattern A” 706 embossments would be coupled to ground 133. The controller 212 may control a position of the switch 702 in response to expected charge build up conditions on the workpiece. For instance, if one portion of the workpiece was expected to encounter relatively higher charge build up than other portions of the workpiece, the switch 702 may be positioned to selectively couple more grounded embossments to ground in the area of expected higher charge build up.

FIG. 8 illustrates one example of selectively coupling certain grounded embossments to ground with the switch 702 of FIG. 7 in response to an expected last contact area of the workpiece to the embossed platen 810 when the workpiece is removed from the embossed platen 810. For instance, the embossed platen 810 may include a lift mechanism having three lift pins 802, 804, 806 to drive the workpiece away from a clamping surface of the embossed platen 810. As some workpieces such as semiconductor wafers become more finely finished and clean on the backside of the wafer, undesirable “sticking” or adhesion of the wafer to the clamping surface has been noticed. Accordingly, the lift mechanism with lift pins 802, 804, 806 may be configured to release the wafer in such a way that a last contact area between the wafer and the clamping surface of the embossed platen 810 occurs substantially adjacent to one of the lift pins 802, 804, 806 as the wafer is temporarily tipped in that direction. This may be accomplished by making one of the lift pins 802, 804, 806 shorter than the others or driving one of the lift pins at a slower rate than the other lift pins. In this way, a force due to weight of the wafer results in a maximum release force to promote the release of the wafer.

In the embodiment of FIG. 8, the area “A” of the embossed platen 810 proximate the lift pin 806 is configured to be the last contact point of the wafer to the embossed platen 810. The switch 702 may be configured to select both “embossment pattern A” 706 including four embossments 830, 831, 832, 833 in this instance and “embossment pattern B” 708 that include the remainder of grounded embossments shown in different hatching. In this way, additional grounded embossments proximate an expected last contact area “A” are provided to provide for additional charge up control for that region of the workpiece.

Accordingly, there is provided an embossed platen with grounded embossments. The grounded embossments contact a backside of a workpiece supported thereby to provide for enhanced charge control protection. A large number of grounded embossments provide additional grounding paths to provide for effective charge build up control. The large number of grounded embossments also provides redundancy in case one or more grounded embossments do not make sufficient electrical contact to the backside of the workpiece. In addition, the surface of the grounded embossments that contacts the backside of the workpiece may have a planar disk shape to limit damage to the backside of the wafer. Accordingly, particle contamination can be better controlled compared to sharp lift pins that can damage the backside of the workpiece. The use of such sharp lift pins can even be eliminated. In addition, a switch can be provided for flexibility in controlling the number of grounding contact points to the workpiece. This can enable selected patterns of embossments to be coupled to ground in response to expected charge build up conditions on the workpiece.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

Having thus described at least one illustrative embodiment of the invention, various alterations, modifications, and improvements will readily occur to those skilled in the art. Such alterations, modifications, and improvements are intended to be within the scope of the invention. Accordingly, the foregoing description is by way of example only and is not intended as limiting.

What is claimed is:

1. An embossed platen comprising:
a dielectric layer;
a plurality of embossments on a surface of the dielectric layer to support a workpiece, each of a first plurality of the plurality of embossments having a conductive portion to contact a backside of the workpiece when the workpiece is in a clamped position; and
a conductor to electrically couple the conductive portion of the first plurality of embossments to ground.

2. The embossed platen of claim 1, wherein the first plurality of embossments are greater than 40% of the plurality of embossments.

3. The embossed platen of claim 1, wherein the first plurality of embossments are greater than 70% of the plurality of embossments.

4. The embossed platen of claim 1, wherein the conductive portion is sized to substantially cover a top surface of the first plurality of embossments.

5. The embossed platen of claim 4, wherein the conductive portion has a planar disk shaped surface to contact the backside of the workpiece when the workpiece is in the clamped position.

6. The embossed platen of claim 1, further comprising a switch coupled to the conductor, wherein the switch is configured to selectively couple all or a subset of the first plurality of conductive portions to ground.

7. The embossed platen of claim 6, further comprising a controller configured to control a position of the switch to couple a desired pattern of the first plurality of conductive portions to ground in response to expected charge build up conditions on the workpiece.

8. The embossed platen of claim 6, further comprising a controller configured to control a position of the switch to couple a desired pattern of the first plurality of conductive portions to ground in response to an expected last contact area of the workpiece to the embossed platen when the workpiece is removed from the embossed platen.

9. An ion implanter comprising:
an ion generator configured to generate ions and direct the ions towards a front surface of a workpiece; and
an embossed platen comprising:
a dielectric layer;
a plurality of embossments on a surface of the dielectric layer to support the workpiece, each of a first plurality of the plurality of embossments having a conductive portion to contact a backside of the workpiece when the workpiece is in a clamped position; and
a conductor to electrically couple the conductive portion of the first plurality of embossments to ground.

10. The ion implanter of claim 9, wherein the ion generator comprises an ion source configured to generate an ion beam of the ions.

11. The ion implanter of claim 9, wherein the ion generator comprises a plasma source configured to generate plasma in a process chamber, and the ion implanter further comprises a bias source to bias the workpiece to attract ions from the plasma towards the workpiece, wherein the embossed platen is positioned in the process chamber.

12. The ion implanter of claim 9, further comprising a switch coupled to the conductor, wherein the switch is configured to selectively couple all or a subset of the first plurality of conductive portions to ground.

13. The ion implanter of claim 12, further comprising a controller configured to control a position of the switch to couple a desired pattern of the first plurality of conductive portions to ground in response to expected charge build up conditions on the workpiece.

14. The ion implanter of claim 12, further comprising a controller configured to control a position of the switch to couple a desired pattern of the first plurality of conductive portions to ground in response to an expected last contact area of the workpiece to the platen when the workpiece is removed from the platen.

15. An embossed platen comprising:
a dielectric layer;
a plurality of embossments on a surface of the dielectric layer to support a workpiece, at least one of the plurality of embossments having a conductive portion to contact a backside of the workpiece when the workpiece is in a clamped position; and
a conductor to electrically couple the conductive portion to ground.

16. The embossed platen of claim 15, wherein the conductive portion is sized to substantially cover a top surface of the at least one embossment.

17. The embossed platen of claim 16, wherein the conductive portion has a planar disk shaped surface to contact the backside of the workpiece when the workpiece is in the clamped position.

18. The embossed platen of claim 15, wherein the conductive portion comprises diamond like carbon.
